(19) United States
(12) Patent Application Publication
(10) Pub. No.: US 2023/0080871 A1
(43) Pub. Date: Mar. 16, 2023

(54) METHOD FOR ESTIMATING THROAT TEMPERATURE OF BLAST FURNACE BASED ON MULTILAYER ORE-TO-COKE RATIO DISTRIBUTION MODEL

(71) Applicant: ZHEJIANG UNIVERSITY, Hangzhou (CN)

(72) Inventors: Xiaoyu TANG, Hangzhou (CN); Wangzhen JIN, Hangzhou (CN); Zheng HAO, Hangzhou (CN); Xin WANG, Hangzhou (CN); Chunjie YANG, Hangzhou (CN); Wenhai WANG, Hangzhou (CN)

(21) Appl. No.: 17/984,244

(22) Filed: Nov. 10, 2022

Related U.S. Application Data
(63) Continuation of application No. PCT/CN2021/114406, filed on Aug. 25, 2021.

(30) Foreign Application Priority Data
Mar. 22, 2021 (CN) 202110301378.5

(51) Int. Cl. G06F 30/27

(52) U.S. Cl. CPC G06F 30/27; C21B 2300/04; G06F 2119/08

(57) ABSTRACT

Disclosed is a method for estimating a blast furnace throat temperature based on a multilayer ore-to-coke ratio distribution model. According to the method, blast furnace equipment parameters and a burden distribution matrix are utilized, the burden layer profile of each layer is calculated according to the burden distribution movement process, a burden layer distribution model is established in combination with the descending process, and the ore-to-coke ratio of each burden layer is obtained. According to the method, the ore-to-coke ratio distribution of multiple layers and main parameters of a blast furnace are used as input, a generalized regression neural network is used for estimating the temperature at the corresponding measurement position of throat temperature, so as to realize the monitoring of throat temperature in the blast furnace process.

### CROSS-REFERENCE TO RELATED APPLICATIONS

The present application is a continuation of International Application No. PCT/CN2021/114406, filed on Aug. 25, 2021, which claims priority to Chinese Application No. 202110301378.5, filed on Mar. 22, 2021, the contents of both of which are incorporated herein by reference in their entireties.

### TECHNICAL FIELD

The present disclosure relates to the technical field of energy and power engineering, in particular to a method for estimating a blast furnace throat temperature based on a multilayer ore-to-coke ratio distribution model.

### BACKGROUND

With the increasing demand of steel in the world, the steel output quantity and quality have become an important symbol to depict a country's developed degree and economic strength. Iron and steel industry is one of the mainstay industries in modern countries. It is also a major consumption of source and energy, and a large source of environmental pollution, which has vital impacts on the sustainable development.

Blast furnace iron producing is the core of iron and steel production. It is the process of reducing iron from iron ore and other iron-containing compounds to provide raw materials for subsequent steelmaking links. The quality of molten iron produced by the blast furnace directly affects the product quality of subsequent links, such as steelmaking and steel processing. Operations on a blast furnace are to keep a stable and effective internal gas flow. The internal gas flow is the main carrier of heat and chemical energy during a smelting process inside the blast furnace, affecting blast furnace condition, fuel utilization ratio, product yield and quality, and blast furnace life-span. Therefore, effective monitoring on the gas flow distribution at the top of the blast furnace top is the basis of proper iron producing process operation, control and optimization. Throat temperature measurement directly reflects the gas flow distribution at the blast furnace top.

A cross temperature measuring device with thermocouple sensors is the most common method to monitor the throat temperature. This method has good dynamic performance. But, because the sensors are direct contact with high-temperature gas flow, the sensors are easy to be damaged or malfunction, especially the sensors located in the blast furnace centerline. Because of the closure and the long maintenance cycle of the blast furnace, once one of the temperature sensors is damaged or fails, it is difficult to replace the failed sensor. Therefore, the throat temperature monitoring cannot be maintained, and the proper blast furnace monitoring, control and optimization are to be severe affected.

Based on the different permeabilities between coke and ore, it is a reliable method to estimate the blast furnace throat temperature by using the Ore to Coke Ratio (OCR) of a burden layer. The gas flow starts from the raceway of the hearth, flows upward through the cohesive zone, and sequentially passes through the burden layers upwards to reach the top of the blast furnace. The influence of burden layers on the gas flow in the furnace is unignorable, and should be considered in the throat temperature estimation. Since the OCR-based method has taken the gas flow motion into consideration, it has more stability, reliability and interpretability than pure data-driven temperature estimation methods.

Therefore, a method for estimating the blast furnace throat temperature in real time based on the ore-to-coke ratio distribution of multilayer burden is proposed.

### SUMMARY

In view of the shortcomings of the existing throat temperature measurement technology, the purpose of the present disclosure is to provide a method for estimating a blast furnace throat temperature based on a multilayer ore-to-coke ratio distribution model. In this method, according to the blast furnace size parameters and burden distribution process parameters, combined with the corresponding motion law, a mathematical model of burden distribution of a blast furnace is established, and the ore-to-coke ratio distribution of multilayer burden in the furnace is calculated and is taken as input together with main parameters of the blast furnace (oxygen enrichment rate, cold air temperature, hot air temperature, top temperature and top pressure, etc.). Using the data-driven method of a General Regression Neural Network (GRNN), the temperature of the corresponding position of the throat is estimated, and the on-line monitoring of the throat temperature of the blast furnace is realized. At the same time, when the temperature measuring device of the blast furnace throat fails, a means for the field operators to judge the gas flow distribution is provided, so as to timely adjust the burden distribution matrix and ensure the safe and stable operation of the blast furnace.

To achieve the above purpose, the present disclosure adopts the following technical solution: a method for estimating a blast furnace throat temperature based on a multilayer ore-to-coke ratio distribution model, including the following steps:

Step (1) Obtaining equipment parameters of the blast furnace, burden distribution process parameters, burden parameters, a burden distribution matrix, main operation parameters, main indication parameters of the blast furnace and throat temperature measurement data.

Step (2) Calculating a burden layer profile of each layer according to a burden distribution law, including processes of the burden moving from a storage tank to a chute, moving on the chute, falling from the chute to the burden surface, and forming the burden layer profile.

Step (3) Calculating the burden layer profile of each layer in the furnace according to layer descending rules to realize the iterative cycle of burden layers, the layers have different descending rules in different positions in the blast furnace, and the descent starts from a lowest layer and goes up layer by layer; in the process, the volume of each layer is calculated by a method of segmentation until a top layer descending is completed. A current burden layer distribution of the blast furnace is recorded, and next top layer burden distribution is carried out to prepare for the next descent.

Step (4) Calculating the distribution of the ore-to-coke ratio in each layer.

Step (5) Establishing a throat temperature estimation model based on a generalized regression neural network by taking the ore-to-coke ratio of each layer and the main parameters of the blast furnace as inputs and the measurement point data of the throat temperature as outputs; after the training of the model is completed, inputting the current ore-to-coke ratio of each layer and the main parameters of the blast furnace to obtain an estimated value of the measured throat temperature.

Furthermore, the step (2) specifically includes the following substeps:

Step (2.1) a process of discharging the burden from the storage tank and reaching the chute through a central throat: calculating an initial speed of the burden along the direction of the chute when reaching the chute is calculated according to a known chute length, a chute inclination angle, a central throat length and other parameters based on the law of free fall.

Step (2.2) calculating a speed of the burden when leaving the chute based on the initial speed in (2.1) through stress analysis according to the known chute length, a chute rotation speed and a friction coefficient of the burden on the chute.

Step (2.3) calculating a coordinate position of a tip of a burden pile, which is formed when the burden reaches the burden layer surface, in a radius direction of the blast furnace according to a known chute inclination angle and a burden line height.

Step (2.4) determining the burden layer profile according to known internal and external burden pile angles and the coordinate position of the tip of the burden pile, an abscissa of the tip of burden pile is determined in step (2.3), and an ordinate is calculated according to the principle that a single-loop burden volume in the burden distribution matrix is equal to a volume between two successive burden layer profiles.

Step (2.5) taking a burden layer surface formed by a previous inclination angle as a new initial burden layer profile, calculating a burden layer profile function from a second chute to a last chute inclination angle in turn according to the burden distribution matrix, and completing a burden distribution cycle of the burden distribution matrix, with a final result being the burden layer profile of a certain layer (ore bed or coke bed).

Furthermore, the step (3) specifically includes the following substeps:

Step (3.1) carrying out the burden descending process if a height of the burden line of the top layer is higher than a set value; otherwise, taking the burden surface of the current top layer as an initial burden layer surface, and calculating the burden layer profile of the top layer according to the burden distribution matrix and the step (2).

Step (3.2) burden layer descending trajectory: the burden has different descending trajectories at different positions in the blast furnace, and vertical descent occurs at the throat and bosh of the furnace, while the radial coordinates remain unchanged; the radial and axial movement laws of the burden at a furnace shaft and a furnace waist are calculated according to the principle of similar triangles and a uniform descent mode.

Step (3.3) a calculation method of a descending volume of each layer: dividing each layer into several triangles according to the shapes of upper and lower interfaces thereof, calculating an area of each triangle, and taking a result of the accumulation of the volumes enclosed by rotation around a center line of the blast furnace as the volume of each layer.

Step (3.4) the layer above descending after the last layer of the burden descends, and a descent volume being the burden volume of the last layer; applying the falling rules in (3.2) and (3.3) to each burden layer one by one upwards till the top layer, and after the top layer descends, an upper interface thereof being read into the next burden distribution matrix as a new initial burden layer surface, returning to step (3.1).

Furthermore, in the step (4), the ore-to-coke ratio is calculated by the following calculation formula:

$${OCR}_{k} ( x ) = \begin{matrix}\frac{{{γ}_{o} ( x )}_{k} - {{γ}_{c} ( x )}_{k - 1}}{{{γ}_{c} ( x )}_{k - 1} - {{γ}_{o} ( x )}_{k - 2}} & 1 < k \leq K\end{matrix}$$

where x represents a distance between a certain point and the center line of the blast furnace, γ(x)ₖ represents a burden surface distribution function of a k^{th} layer, and the subscripts o and c are used to distinguish an ore layer from a coke layer, K represents a number of selected burden layers, OCRₖ (x) represents the ore-to-coke ratio of the k^{th} layer; the selected multiple burden layers ranges from the throat position to the bosh position.

Furthermore, the step (5) specifically includes the following substeps:

Step (5.1) time-registering the main parameters of the blast furnace and the measurement data of the throat temperature with the burden distribution process, and selecting the main parameters of the blast furnace and the measurement data of the throat temperature which are consistent with a time of the burden distribution matrix.

Step (5.2) data preprocessing, including data cleaning and normalization.

Step (5.3) the generalized regression neural network being composed of an input layer, a pattern layer, a summation layer and an output layer, and the relationship between input and output is expressed by the following formula:

$$E [ T \vert U ] = \frac{{\int }_{- ∞}^{∞} Tg ( U , T ) dT}{{\int }_{- ∞}^{∞} g ( U , T ) dT}$$

where T represents an output result of GRNN, and the input vector U represents a N×1-dimensional vector composed of the ore-to-coke ratio of each layer and the main parameters of the blast furnace, E[T|U] represents an expected value of an output T of a given input vector U and g(U,T) represents a joint probability density function of U and T.

Step (5.4) training the model by taking the main parameters of the blast furnace and ore-to-coke ratios of every burden layer in the multilayer in a training set as an output vector and a throat temperature value as an output vector; after the training of the model is completed, inputting the current main parameters of the blast furnace and ore-to-coke ratios of every burden layer in the multilayer to obtain the estimated throat temperature.

The present disclosure has the following beneficial effects: the effective monitoring of the gas flow distribution at the top of the blast furnace is of great significance to the operation, control and optimization of the iron producing process. The throat temperature is one of the key indexes that directly reflect the gas flow distribution at the top of the blast furnace. According to the present disclosure, a method for establishing the blast burden layer structure distribution is proposed by using the original data of the blast furnace, and the ore-to-coke ratio of multiple layers of burden in the burden layer structure is taken as the key factor affecting the gas flow distribution at the top of the furnace, thus realizing the throat temperature estimation. When the throat temperature measuring device of the blast furnace has a fault or needs to be replaced, the temperature estimated value provided by the present disclosure can effectively help field workers to timely adjust and stabilize the state of the blast furnace, and ensure the production efficiency and product quality.

### BRIEF DESCRIPTION OF DRAWINGS

FIG. 1 is a flow chart of a method for estimating a blast furnace throat temperature based on a multilayer ore-to-coke ratio distribution model according to an embodiment of the present disclosure.

FIG. 2 is a schematic diagram of measuring points of a throat temperature measuring device (a cross temperature measuring device) according to an embodiment of the present disclosure.

FIG. 3 is a schematic diagram of the dropping process of burden according to an embodiment of the present disclosure.

FIG. 4 is a schematic diagram of construction of a burden surface function according to an embodiment of the present disclosure.

FIG. 5 is a schematic diagram of burden descent according to an embodiment of the present disclosure.

FIG. 6 is a schematic diagram of the method of calculating the volume of the burden layer according to an embodiment of the present disclosure.

FIG. 7 is a flow chart of establishing a burden layer model according to an embodiment of the present disclosure.

FIG. 8 is a schematic diagram of a GRNN network structure according to an embodiment of the present disclosure.

FIG. 9 shows the estimation results of two temperature measurement points by two methods according to an embodiment of the present disclosure.

### DESCRIPTION OF EMBODIMENTS

The present disclosure will be further explained with reference to the drawings and specific embodiments.

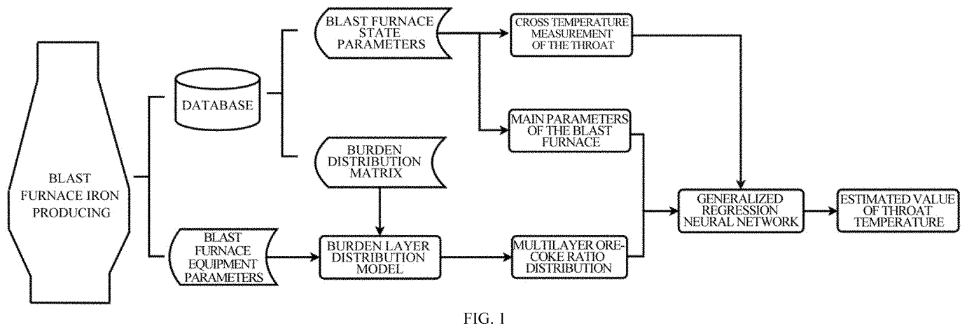

FIG. 1 shows the overall flow of a method for estimating a blast furnace throat temperature based on a multilayer ore-to-coke ratio distribution model according to an embodiment of the present disclosure. The burden layer distribution model of a blast furnace is established by using equipment parameters of the blast furnace, a burden distribution matrix and state parameters of the blast furnace. Data processing of state parameters of the blast furnace and burden distribution matrix includes sampling synchronization, data cleaning and feature selection. The processed state parameters are combined with the multilayer ore-to-coke ratio burden distribution to obtain the required input data. A GRNN algorithm is used to obtain the estimated throat temperature.

In order to realize the modeling process of the burden layer structure, the following assumptions are made:

A. the volume change of the burden in the movement process is ignored, and the collapse and deformation of the burden surface is not considered.

B. the burden surface is central symmetrically distributed in the center.

C. the burden surface and burden flow remain continuous.

D. the burden flow speed of the burden distribution in each rotating circle of the chute is kept stable.

E. the chute and burden flow shall be implemented strictly according to the burden distribution matrix.

The embodiment of the present disclosure relates to a method for estimating a blast furnace throat temperature based on a multilayer ore-to-coke ratio distribution model, and each step is specifically described as follows:

(1) Equipment parameters of the blast furnace, burden distribution process parameters, burden parameters, a burden distribution matrix, main operation parameters, main indication parameters of the blast furnace and throat temperature measurement data are obtained as follows:

The equipment parameters of the blast furnace include a total blast furnace height, a throat height, a bosh height, a body height, a waist height, a throat radius, a body inclination angle, a bosh radius and a waist inclination angle.

The burden distribution process parameters include a central throat length h₀, a throttle opening S, a chute length l, a chute tilting distance b, a chute rotating speed ω, a chute friction coefficient μ and a burden line depth H.

The burden parameters include the average particle size D_{o,c}, the average density ρ, the inner stacking angle φᵢₙ and the outer stacking angle φₒᵤₜ of the ore coke.

The burden distribution matrix includes a chute inclination angle the number of rotation turns corresponding to each inclination angle, and the single-circle ore coke volume.

The main parameters of the blast furnace include an oxygen enrichment rate (%), a permeability index (%), a cold gas flow rate (m3/h), an oxygen enrichment flow rate (m³/h), a top pressure (kPa), hot and cold air temperatures (° C.), a top temperature (° C.) and a blast humidity (%).

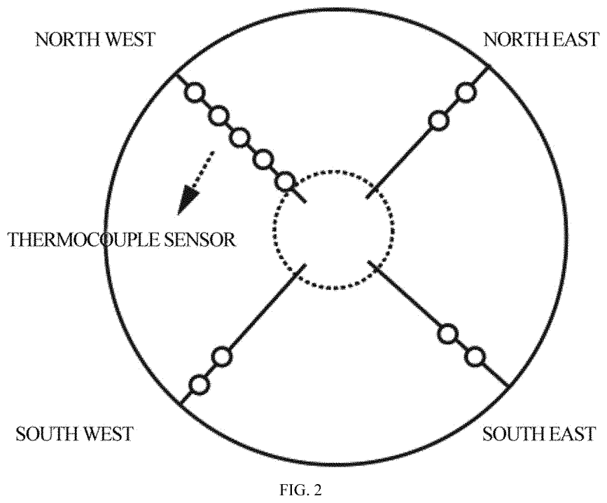

The schematic diagram of the throat temperature measuring device is shown in FIG. 2, which is installed at the blast furnace throat and detected by a thermocouple sensor.

(2) The burden layer profile of each layer is calculated according to the burden distribution law and the principle of equal volume, and the specific steps include:

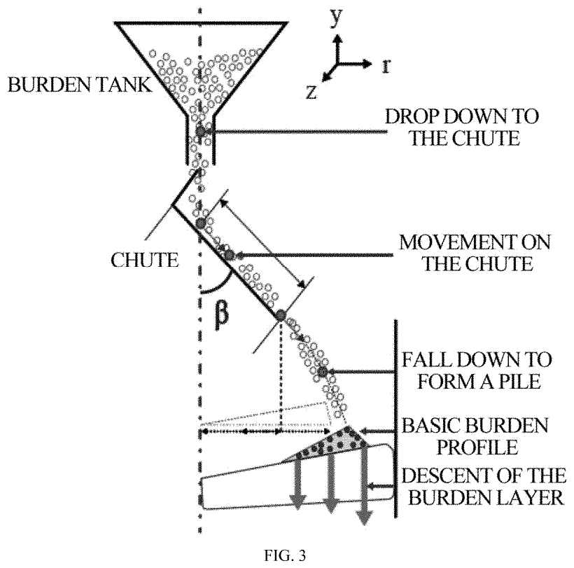

FIG. 3 shows the concrete schematic diagram of the falling process of the burden.

(2.1) The burden (ore or coke) is discharged from the hopper and enters the rotary chute through the central throat. Assuming that the movement of the burden before it reaches the chute falls freely, and considering the collision process, the initial velocity of particles entering the chute is:

$${v}_{1} = {K}_{f} cos β \sqrt{{v}_{0}^{2} + 2 g ( {h}_{0} + \frac{b}{sin β} )}$$

where v₀ is the speed of particles leaving the hopper and K_{f} is an impact attenuation coefficient.

(2.2) When the burden with a mass of m is moving on the chute, it is subjected to various forces, including a gravity mg, a chute reaction force F_{N}, a friction force F_{f}, an inertial centrifugal force F_{c}, an inertial Coriolis force F_{Coli}, and the force F_{L} between the burden and the chute sidewall caused by rotation. According to the force analysis of particles and Newton's second law, the speed of the burden leaving the chute is calculated as follows:

$${v}_{2} = {[ 2 gl ( sin β - μ cos β ) + {v}_{1}^{2} + 4 {π}^{2} {ω}^{2} {l}^{2} cos β ( cos β + μ sin β ) ]}^{\frac{1}{2}}$$

(2.3) The burden undergoes a projectile motion in the empty area, and is affected by its own gravity and drag force of the rising gas. Because the drag force of the gas is negligible, it can be considered that the burden moves with an initial speed of v₂, and a vertical acceleration of g. The distance d between the tip point of the burden pile and the main shaft of the blast furnace in the horizontal direction is calculated by the following formula:

$$t = \frac{{L}_{x}}{{v}_{2} cos β} = \frac{{L}_{y}}{ω l cos β} \\ H = {L}_{x} tan β + \frac{mg}{2 m {v}_{2}^{2} {cos}^{2} β} {L}_{x}^{2} - l ( 1 - sin β ) \\ d = \sqrt{{( {L}_{x} + l cos β )}^{2} + {L}_{y}^{2}}$$

where t is a falling time of the burden, Lₓ is a projection distance of the burden trajectory in the radial direction and L_{y} is a projection distance of the burden trajectory in the tangential direction.

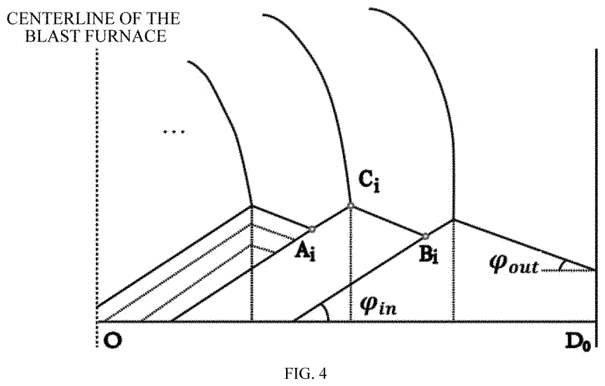

(2.4) The shape of the burden pile is shown in FIG. 4. According to the internal and external stacking angles φᵢₙ and φₒᵤₜ of the ore coke, the slopes of two line segments of the burden surface can be obtained. The burden layer profile function form is as follows:

$$γ ( x ) = \{ \begin{matrix}tan {φ}_{in} ( x - {x}_{peak} ) + {y}_{peak} , {x}_{Left} \leq x < {x}_{peak} \\ tan {φ}_{out} ( x - {x}_{peak} ) + {y}_{peak} , {x}_{peak} \leq x \leq {x}_{R ight}\end{matrix}$$

where (Xₚₑₐₖ, Yₚₑₐₖ) is the coordinate of the tip of the burden pile, Xₚₑₐₖ is d calculated in (2.3), and X_{Left} and X_{Right} radial coordinates of the left and right end points of the pile. yₚₑₐₖ is obtained through calculation according to the principle that the volume of single-circle burden in the burden distribution matrix is equal to the volume between two successive burden layer profiles, thereby obtaining the burden layer profile function.

(2.5) After burden distribution is completed for all inclination angles of a burden distribution matrix, the result is the burden layer profile of a certain layer (an ore layer or a coke layer). According to FIG. 4, the burden layer profile function of the multi-circle burden distribution mode can be expressed as:

$${γ}_{i} ( x ) = \{ \begin{matrix}{γ}_{i - 1} ( x ) , & 0 \leq x < {x}_{{A}_{i}} \\ tan {φ}_{in} ( x - {x}_{{C}_{i}} ) + {y}_{{C}_{i}} & {x}_{{A}_{i}} \leq x < {x}_{{C}_{i}} \\ tan {φ}_{out} ( x - {x}_{{C}_{i}} ) + {y}_{{C}_{i}} & {x}_{{C}_{i}} \leq x < {x}_{{B}_{i}} \\ {γ}_{i - 1} ( x ) , & {x}_{{B}_{i}} \leq x \leq {D}_{0}\end{matrix}$$

where (x_{ci}, y_{ci}) is the coordinate of the pile tip Cᵢ with the i^{th} inclination angle, x_{Ai} and x_{Bi} are the radial coordinates of the intersection points of the new burden line and the original burden surface, and D₀ is the radius of the throat.

(3) The burden layer profile of each layer in the furnace is calculated according to the descending law, and the iterative cycle of the burden layer is realized. The specific steps are as below:

(3.1) If the height of the burden line of the top layer is higher than the set value, the descending process is carried out. Otherwise, the current burden surface of the top layer is taken as the initial burden layer surface, and the burden layer profile of the top layer is calculated according to the burden distribution matrix and the step (2).

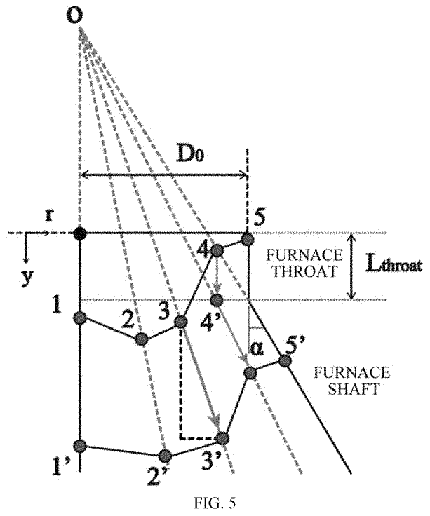

(3.2) FIG. 5 shows the lowering mode of the burden at the throat and shaft. Point “O” is the intersection of the central axis of the blast furnace and the extension line of the shaft wall, a is the angle of the shaft of the blast furnace and Lₜₕᵣₒₐₜ is the length of the throat area. In the throat area, it is assumed that the original position of the burden is (r,y), and the position after drop of a unit volume ΔV is

$$( r , \frac{4 \times Δ V}{π {D}_{0}^{2}} + y ) .$$

In the furnace shaft area, the burden trajectory becomes along the ray from point O, and the new position (r′,y′) is:

$${y}^{′} = {[ {( \frac{{D}_{0}}{2 tan α} - {L}_{throat} + y )}^{3} + \frac{3 Δ V}{{π ( tan α )}^{2}} ]}^{\frac{1}{3}} - \frac{{D}_{0}}{2 tan α} + {L}_{throat}$$

$${r}^{′} = r \times \frac{\frac{{D}_{0}}{2 tan α} - {L}_{throat} + {y}^{′}}{\frac{{D}_{0}}{2 tan α} - {L}_{throat} + y}$$

The law of the waist part is consistent with that of the shaft part, and the law of the bosh part is consistent with that of the throat part, so the formula will not be described in detail.

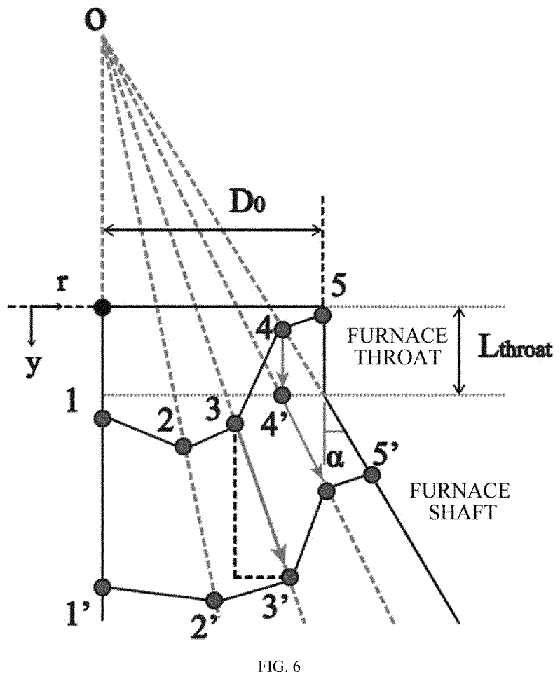

(3.3) The cross section of each burden layer is shown in FIG. 6 (a), and the calculation method of the burden volume of each layer is: dividing the burden of each layer into several triangles according to the shapes of its upper and lower interfaces, as shown in FIG. 6 (b), calculating the area of each triangle, and taking the accumulated results of the volumes enclosed by its rotation around the centerline of the blast furnace as the volume of each layer.

(3.4) The layer above last descends after the last layer of the burden descends, and the descent volume is the burden volume of the last layer. By applying the falling rules in (3.2) and (3.3) to each burden layer one by one upwards till the top layer, after the top layer descends, an upper interface thereof is taken as a new initial burden layer surface and read into the next burden distribution matrix, return to (3.1).

(4) The ore-to-coke ratio distribution in each layer is calculated.

The ore-to-coke ratio is a parameter describing the radial coke thickness of the blast furnace. Assuming that the last batch of blast furnace raw materials is ore and the penultimate batch is coke, the calculation formula of the ore-to-coke ratio is obtained by combining the above burden layer profile model:

$${OCR}_{k} ( x ) = \begin{matrix}\frac{{{γ}_{o} ( x )}_{k} - {{γ}_{c} ( x )}_{k - 1}}{{{γ}_{c} ( x )}_{k - 1} - {{γ}_{o} ( x )}_{k - 2}} & 1 < k \leq K\end{matrix}$$

where x represents a distance between a certain point and the center line of the blast furnace, γ(x)ₖ represents a burden surface distribution function of a k^{th} layer, and the subscripts o and c are used to distinguish an ore layer from a coke layer, K represents a number of selected burden layers, OCRₖ (x) represents the ore-to-coke ratio of the k^{th} layer; the selected multiple burden layers ranges from the throat position to the bosh position.

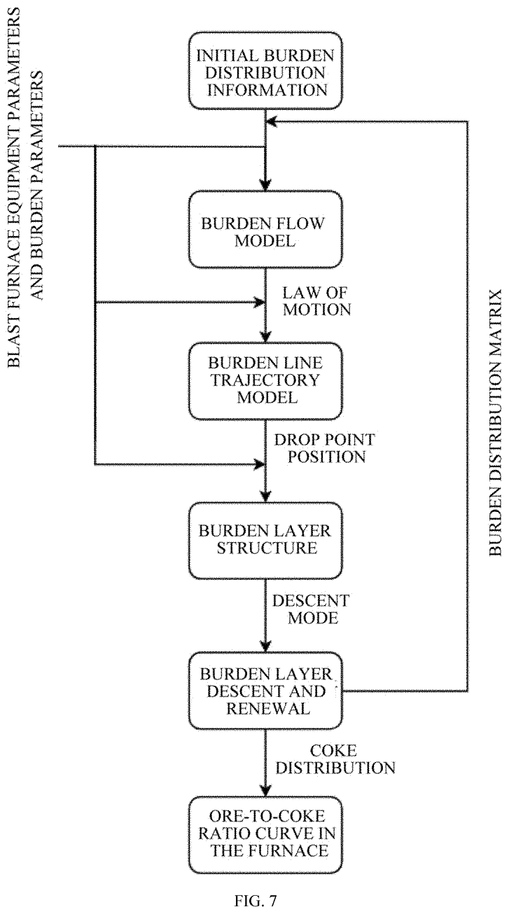

FIG. 7 shows the flow chart of building the burden layer distribution model, including steps (2), (3) and (4).

(5) The ore-to-coke ratio of each layer and the main parameters of the blast furnace are taken as inputs and the temperature measurement point data of the throat as outputs, the throat temperature estimation model is established based on the generalized regression neural network. This step consists of the following substeps:

(5.1) The main parameters of the blast furnace and the measurement data of the throat temperature are time-registered with the burden distribution process, and the main parameters of the blast furnace and the temperature measurement data of the throat which are consistent with a time of the burden distribution matrix are selected.

(5.2) Data preprocessing, including data cleaning and normalization. In order to ensure the validity and reliability of the data, input/output combinations with invalid or missing values (data such as sensor failure or malfunction) are eliminated from the data.

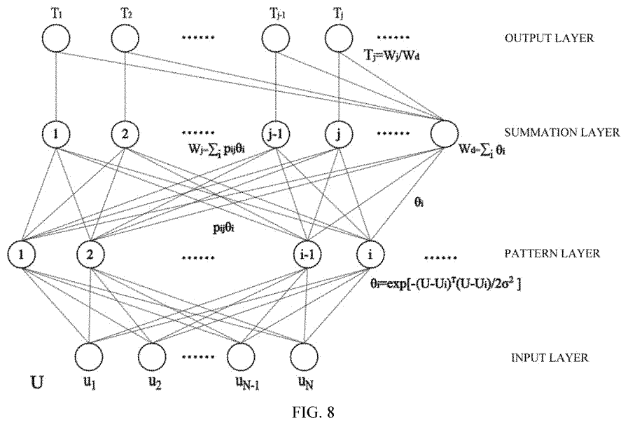

(5.3) The structure of a generalized regression neural network is shown in FIG. 8, which is divided into four layers. The first layer is the input neuron, and the input vector U is a N×1-dimensional vector composed of the ore-to-coke ratio of each layer and main parameters of the blast furnace. These variables are expressed in a vector form (u₁, u₂, . . . , u_{N}).

After receiving the information, the neurons in the second pattern layer systematically process and combine the data. The number of neurons in the pattern layer is equal to the number of samples included in the selected blast furnace period, and the transfer function of the i^{th} neuron to input and output processing is:

θ=e^{-(U-Ui)T(U-Ui)/2σ}^{²}

where θᵢ is the output of the neuron in the pattern layer, Uᵢ is the input sample vector corresponding to the i^{th} neuron, and a is a smoothing factor.

The neurons in the third layer strengthen the output of the second layer, and perform arithmetic summation and weighted summation among the outputs, with the following formula:

W₁=Σᵢθᵢ

W₂=Σᵢpᵢθᵢ

where W₁ is the arithmetic sum result, W₂ is the weighted sum result and pᵢ is the weight value corresponding to θᵢ.

After the results are summed and transmitted to the last output neuron, the estimated value of the output measured temperature of the throat is obtained.

T=W₂/W₁

where T is an the estimated value of the output throat temperature.

The internal logical relationship between the input and output of the GRNN method is represented by the following formula:

$$E [ T \vert U ] = \frac{{\int }_{- ∞}^{∞} Tg ( U , T ) dT}{{\int }_{- ∞}^{∞} g ( U , T ) dT}$$

where E[T|U] is the expected value of the output T of a given input vector U, and g(U,T) is the joint probability density function of U and T.

(5.4) The model is trained by taking the main parameters of the blast furnace and ore-to-coke ratios of every burden layer in the multilayer in a training set as an output vector and a throat temperature value as an output vector; after the training of the model is completed, the current main parameters of the blast furnace and the ore-to-coke ratios of every burden layer in the multilayer are input to obtain the throat temperature.

In this embodiment, the main parameter data, throat temperature measuring point data and blast furnace burden distribution matrix of a blast furnace of 2650 m³ in two months of a certain year and in China are selected. The radius length of the throat part of the blast furnace is 4.15 m, and the temperature measuring device shown in FIG. 2 is used. The method is evaluated by selecting two measuring points A and B at different positions. By establishing the model, the burden layer distribution and the ore-to-coke ratio distribution of each layer are obtained. The ore-to-coke ratio distribution of multiple layers and main parameters are used as inputs. A total of 360 samples are selected, the first 300 samples are used for training and the last 60 samples are used for testing.

For a more comprehensive analysis and discussion, two methods are used to estimate the temperature:

(1) Classical method: only the OCR distribution and main state parameters of the top layer are adopted.

(2) The method provided by the present disclosure: the OCR distribution and main state parameters of multiple layers are adopted.

Statistic indicators including MAPE (mean absolute percentage error), MAE (Mean Absolute Error) and RMSE (Root Mean Square Error) are used to evaluate the estimation effect of the model. The three indicators are calculated as follows:

$$RMSE = \sqrt{\frac{1}{M} {\sum }_{i = 1}^{M} {( y ( i ) - \tilde{y} ( i ) )}^{2}}$$

$$MAE = \frac{1}{M} {\sum }_{i = 1}^{M} \vert y ( i ) - \tilde{y} ( i ) \vert$$

$$MAPE = \frac{1}{M} {\sum }_{i = 1}^{M} \vert \frac{y ( i ) - \tilde{y} ( i )}{y ( i )} \vert \times 100 \%$$

where y(i) is the measured value of throat temperature, \tilde{y}(i) is the estimated value of throat temperature and M is the number of samples.

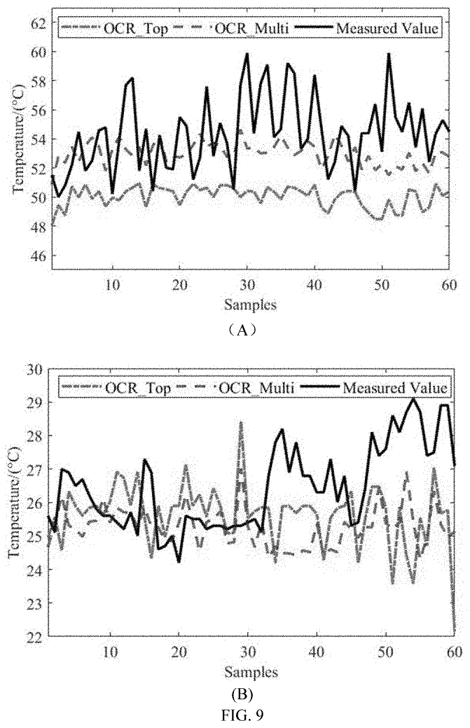

The result of that two methods are shown in FIG. 9, in which OCR_TOP is the result of the traditional method, and OCR_Multi is the method propose by the present disclosure. The evaluation results are as follows:

| | GRNN | | | | | |
|---|---|---|---|---|---|---|
| | Position | | | | | |
| | A | | | B | | |
| | | The present | Improvement | | The present | Improvement |
| Algorithm | Traditional | disclosure | rate (%) | Traditional | disclosure | rate (%) |
| MAPE | 7.84% | 4.42% | 43.62% | 5.71% | 5.27% | 7.71% |
| MAE | 4.36° C. | 2.45° C. | 43.81% | 1.55° C. | 1.43° C. | 7.74% |
| RMSE | 5.05° C. | 3.02° C. | 40.20% | 2.07° C. | 1.85° C. | 10.63% |

As shown in the figure, the ore-to-coke ratio of multiple layers is obviously closer to the measured value than only considering the top layer distribution. The overall trend of the results of the method provided by the present disclosure is consistent with the measured temperature. By changing the dimension of the input vector from a single layer to multiple layers, a better temperature estimation result and a higher accuracy are obtained without over-fitting. The validity and reliability of the proposed method are proved.

It can be seen from the table that taking the distribution of the OCR of multiple layers as input features can promote the prediction results. The accuracy of all evaluation criteria is the highest at point B, with MAPE of 5.27%, MAE of 1.43° C. and RMSE of 1.85° C. The column about the improvement rates of these two points shows the same results as those in FIG. 9, which intuitively proves that the temperature estimation method proposed by the present disclosure is superior to the traditional method.

The above specific embodiments have explained the technical solution and beneficial effects of the present disclosure in detail. It should be understood that the above embodiments are only the most preferred embodiments of the present disclosure, and are not intended to limit the present disclosure. Any modification, supplement, equivalent substitution, etc. made within the scope of the principles of the present disclosure should be included in the scope of protection of the present disclosure.

What is claimed is:

1. A method for estimating a blast furnace throat temperature based on a multilayer ore-to-coke ratio distribution model, comprising the following steps:
step (1) obtaining equipment parameters of the blast furnace, burden distribution process parameters, burden parameters, a burden distribution matrix, main operation parameters, main indication parameters of the blast furnace and throat temperature measurement data;
step (2) calculating a burden layer profile of each layer according to a burden distribution law, comprising processes of the burden moving from a storage tank to a chute, moving on the chute, descending from the chute to the burden surface, and forming the burden layer profile, which is as follows:
step (2.1) discharging the burden from the storage tank and reaching the chute through a central throat, comprising: calculating an initial speed of the burden along the direction of the chute when reaching the chute, according to a known chute length, a chute inclination angle, a central throat length and other parameters based on a law of free fall;
step (2.2) calculating a speed of the burden when leaving the chute based on the initial speed in step (2.1) through stress analysis according to the known chute length, a chute rotation speed and a friction coefficient of the burden on the chute;
step (2.3) calculating a coordinate position of a tip of a burden pile, which is formed when the burden reaches the burden layer surface, in a radius direction of the blast furnace according to a known chute inclination angle and a burden line height;
step (2.4) determining the burden layer profile according to known internal and external burden pile angles and the coordinate position of the tip of the burden pile, wherein an abscissa of the tip of burden pile is determined in step (2.3), and an ordinate is calculated according to the principle that a single-loop burden volume in the burden distribution matrix is equal to a volume between two successive burden layer profiles;
step (2.5) defining a burden layer surface formed by a previous inclination angle as a new initial burden layer profile, calculating a burden layer profile function from a second chute to a last chute inclination angle in turn according to the burden distribution matrix, and completing a burden distribution cycle of the burden distribution matrix, and obtaining a final result as the burden layer profile of a certain layer;
step (3) calculating the burden layer profile of each layer in the furnace according to layer descending rules to implement an iterative cycle of burden layers, wherein the layers have different descending rules in different positions in the blast furnace, and the descent starts from a lowest layer and goes up layer by layer, and wherein the volume of each layer is calculated by a method of segmentation until a top layer descending is completed, a current burden layer distribution of the blast furnace is recorded, and then a next top layer burden distribution is carried out to prepare for the next descent, which is as follows:
step (3.1) carrying out the burden descending process if a height of the burden line of the top layer is higher than a set value, and taking the burden surface of the current top layer as an initial burden layer surface, and calculating the burden layer profile of the top layer, if a height of the burden line of the top layer is not higher than a set value, according to the burden distribution matrix and the step (2);
step (3.2) acquiring a burden layer descending trajectory: the burden has different descending trajectories at different positions in the blast furnace, and vertical descent occurs at the throat and bosh of the furnace, while the radial coordinates remain unchanged; the radial and axial movement laws of the burden at a furnace shaft and a furnace waist are calculated according to the principle of similar triangles and a uniform descending mode;
step (3.3) calculating a descending volume of each layer: dividing each layer into several triangles according to the shapes of upper and lower interfaces thereof, calculating an area of each triangle, and taking a result of the accumulation of the volumes enclosed by rotation around a center line of the blast furnace as the volume of each layer;
step (3.4) defining a descent volume as the burden volume of the last layer when the layer above last descends after the last layer of the burden descends, applying the falling rules in steps (3.2) and (3.3) to each burden layer one by one upwards till the top layer, and defining, after the top layer descends, an upper interface thereof as a new initial burden layer surface and reading the new initial burden layer surface into the next burden distribution matrix, and then returning to step (3.1);
building a blast burden furnace layer burden distribution model through step (2) and step (3);
step (4) calculating the distribution of the ore-to-coke ratio in each layer by the following calculation formula:
$${OCR}_{k} ( x ) = \begin{matrix}\frac{{{γ}_{o} ( x )}_{k} - {{γ}_{c} ( x )}_{k - 1}}{{{γ}_{c} ( x )}_{k - 1} - {{γ}_{o} ( x )}_{k - 2}} & 1 < k \leq K\end{matrix}$$
where x represents a distance between a certain point and the center line of the blast furnace, γ(x)ₖ represents a burden surface distribution function of a k^{th} layer, and the subscripts o and c are used to distinguish an ore layer from a coke layer, and K represents a number of selected burden layers, OCRₖ (x) represents the ore-to-coke ratio of the k^{th} layer, and wherein the selected multilayer burden layers ranges from the throat position to the bosh position;
step (5) establishing a throat temperature estimation model based on a generalized regression neural network by taking the ore-to-coke ratio of each layer and the main parameters of the blast furnace as inputs and the measurement point data of the throat temperature as outputs; inputting, after finishing training the model, the current ore-to-coke ratio of each layer and the main parameters of the blast furnace to obtain a throat temperature estimation, which is as below:
step (5.1) time-registering the main parameters of the blast furnace and the measurement data of the throat temperature with the burden distribution process, and selecting the main parameters of the blast furnace and the measurement data of the throat temperature which are consistent with a time of the burden distribution matrix;
step (5.2) data-preprocessing, comprising data cleaning and normalization;
step (5.3) the generalized regression neural network being composed of an input layer, a pattern layer, a summation layer and an output layer, wherein the relationship between an input and an output thereof is expressed by the following formula:
$$E [ T \vert U ] = \frac{{\int }_{- ∞}^{∞} Tg ( U , T ) dT}{{\int }_{- ∞}^{∞} g ( U , T ) dT}$$
where T represents an output result of GRNN, and the input vector U represents a N×1-dimensional vector composed of the ore-to-coke ratio of each layer and the main parameters of the blast furnace, E[T|U] represents an expected value of an output T of a given input vector U and g(U,T) represents a joint probability density function of U and T;
step (5.4) training the model by taking the main parameters of the blast furnace and ore-to-coke ratios of every burden layer in the multilayer in a training set as an output vector and a throat temperature value as an output vector; inputting, after finishing training the model, the current main parameters of the blast furnace and ore-to-coke ratios of every burden layer in the multilayer to obtain the estimated value of the throat temperature.
